(19) United States
(12) Patent Application Publication
(10) Pub. No.: US 2012/0179388 A1
(43) Pub. Date: Jul. 12, 2012

(54) SYSTEM, METHOD AND PROGRAM FOR EARLY DETECTION OF FAN FAILURE BY MONITORING GREASE DEGRADATION

(75) Inventors: Joseph Kuczynski, Rochester, MN (US); Robert E. Meyer, III, Rochester, MN (US); Amanda E. Mikhail, Rochester, MN (US)

(73) Assignee: INTERNATIONAL BUSINESS MACHINES CORPORATION, Armonk, NY (US)

(21) Appl. No.: 12/986,239

(22) Filed: Jan. 7, 2011

(51) Int. Cl. G06F 19/00; G01N 7/00

(52) U.S. Cl. 702/24; 73/31.05

(57) ABSTRACT

A system for predicting a fan failure has a sensor to detect a gas emitted from grease in the fan. A concentration level of the emitted gas is indicative of grease degradation. The system also has circuitry coupled to the sensor to compare the level of the detected gas to a predetermined level. The system also has an alert apparatus coupled to the circuitry to generate an alert after the circuitry determines that the level of the detected gas exceeds the predetermined level.

### FIELD OF THE INVENTION

The present invention relates generally to fans, and more specifically to a system for determining that a fan is starting to fail, before an actual failure.

### BACKGROUND

Computing systems generate heat during operation, and typically rely on high speed fans for cooling. Without the cooling support of a fan, the system is likely to fail. The mechanical reliability of a high speed fan is dependent on the reliability of a bearing assembly of the fan. Bearing wear accelerates with grease degradation and volatilization of the oil base. As the grease thermally degrades or loses its oil base due to thermal volatilization, bearing wear increases which eventually results in the failure of the fan. Some systems detect actual fan failures and automatically activate a redundant fan or increase the speed of the remaining fans. However, when these remedies are not effective or unavailable, the system enters an over temperature state and eventually throttles processor speed (to reduce power consumption) or simply powers down. Because computing systems and their speed of operation are important, it is important to detect a potential failure of a fan before the actual failure and replace the fan before the computer system is adversely affected.

Fan life is typically determined empirically by the fan manufacturer by subjecting multiple fans of the same type to accelerated aging conditions. An end-of-life value is then derived based on statistical treatment of the test data. A certain number of fans, however, will fail before the calculated end-of-life. A noisy fan or a slow-down in fan speed may indicate an impending fan failure. These indications, however, may not be noticed by an operator or provide sufficient time in which to replace the fan before it completely fails.

Existing methods for detecting grease degradation include the Kinematic Viscosity test, the Acid Number test, the Infrared test, and the Inductive coupled plasma spectroscopy test in which tests a technician periodically tests these properties of the grease using laboratory test equipment. These existing methods, however, require removing the grease from a device in order to perform the tests. Additionally, these tests require a larger sample size of grease than is typically found in a fan bearing. Thus, these tests are not well suited for determining grease degradation in a fan bearing.

Known microchips capable of detecting organic and inorganic gases are commonly used to control indoor air quality and to monitor for pollution. The chips rely on a chemo-sensitive polymer layer which absorbs volatile organic compounds (VOCs) or inorganic compounds in the gas. Sensors integrated into the chip detect gases in the air, and generate an analog signal representative of the level of the gases that was detected. The CMOS single-chip gas detection system as described in the IEEE Journal of Solid-State Circuits in December of 2002 is one example of a currently known gas detector chip.

A smoke detector is a known microchip for detecting gasses. As a compound burns, or erodes, it produces smoke. The smoke detector generates an alarm when it detects the smoke.

### SUMMARY

The present invention resides in a system, program product and method for early detection of fan degradation by monitoring grease degradation in a fan bearing assembly.

In a first embodiment of the present invention, a sensor detects a gas emitted from grease in the fan. A concentration level of the emitted gas is indicative of grease degradation. Circuitry coupled to the sensor compares the level of the detected gas to a predetermined level. An alert apparatus coupled to the circuitry generates an alert after the circuitry determines that the level of the detected gas exceeds the predetermined level.

In a second embodiment of the present invention, program instructions receive from the sensor data representative of detected gas emitted from grease in the fan. The concentration level of emitted gas is indicative of grease degradation. Program instructions compare the level of the detected gas to a predetermined level, and generate an alert responsive to the level of the detected gas exceeding the predetermined level.

### BRIEF DESCRIPTION OF THE SEVERAL VIEWS OF THE DRAWINGS

FIG. 1 illustrates a computer with an internal fan and a fan failure detection device according to one embodiment of the present invention.

FIG. 2 illustrates a bearing assembly within the fan of FIG. 1.

FIG. 3 illustrates a block diagram of the fan failure detection device of FIG. 1 according to one embodiment of the present invention.

FIG. 4 illustrates a flow chart describing a data analysis program within a fan failure detection system according to another embodiment of the present invention.

FIG. 5 is a block diagram of the computer of FIG. 1, excluding the fan and other mechanical parts, and including the data analysis program of FIG. 4.

### DETAILED DESCRIPTION

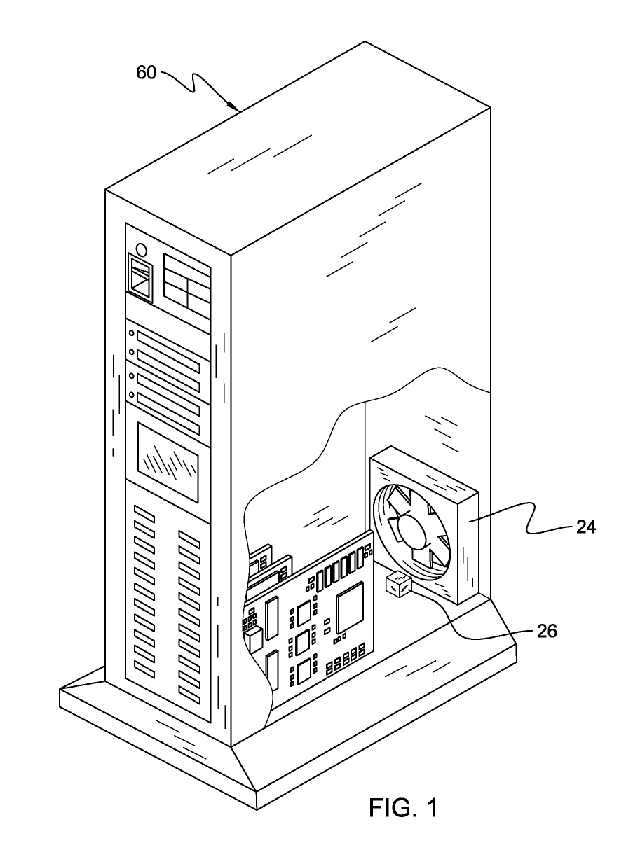

The present invention will now be described in detail with reference to the Figures. FIG. 1 illustrates a computer 60 with an internal fan 24 and a fan failure detection device 26 according to one embodiment of the present invention. Fan 24 cools hardware, such as the processor, within computer 60. In an example embodiment, computer 60 is an enterprise server. Alternately, computer 60 can be a personal computer or any other similar computing device that requires a fan to cool the hardware of the computing device.

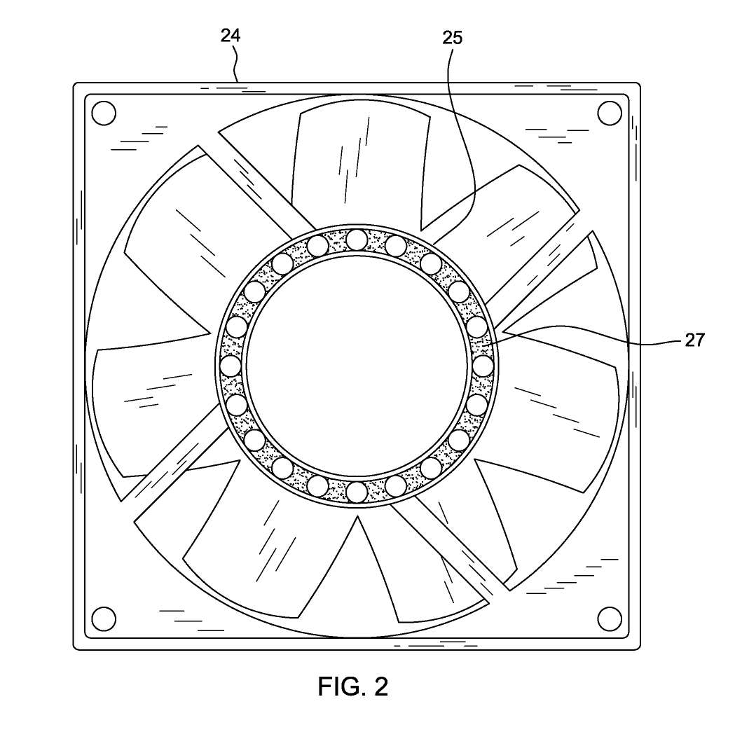

As illustrated in FIG. 2, the fan 24 includes a known bearing assembly 25. In the illustrated example, bearing assembly 25 is a ball bearing assembly comprising two metal rings separated by a plurality of steal balls enclosed in a casing. Alternately, bearing assembly can be a sleeve bearing assembly or any other type of bearing assembly known by those skilled in the art. The bearing assembly 25 is lubricated with a grease 27. In one embodiment of the present invention, grease 27 is a known type such as Kluber GLY 32, an ester oil/synthetic HC oil in a Li soap or KluberQuiet BQ 72-72, an ester oil in a polyurethane thickener. Other examples of grease 27 are Multemp SRL and Multemp SB-M which are synthetic ester oils in a Li soap with Ba additives. The grease 27 includes a known compound that when subjected to a predetermined temperature, indicative of excess friction in the bearing assembly 25 indicative of degradation of the bearing assembly and breakdown of the grease, emits a predetermined gas of sufficient concentration that can be detected by a known gas detector. An example of grease 27 with an additive to the grease is stated below. Fan 24 is prior art except for certain embodiments of the grease containing an additive which emits the predetermined gas at the predetermined temperature.

Referring again to FIG. 1, computer 60 further comprises fan failure detection device 26 which can be located anywhere inside (or even outside) computer 60 that is exposed to the flow of air propelled by fan 24. For example, fan failure detection device 26 can be mounted to any suitable hardware in computer 60, in direct air flow of fan 24 as illustrated in FIG. 1. Fan failure detection device 26 detects the gas emitted upon exposure of the grease to high temperatures associated with start of failure and associated increased friction of a bearing in the fan.

As the grease begins to degrade, as evidenced by increased friction of the bearing and resultant increased temperature of the grease and emission of the gas, the fan nears its end-of-life. Accordingly, the gas-detecting fan failure detection device 26 notifies a user of a potential fan failure. The user may then proactively replace the fan, before complete failure of the fan, to avoid costly system down time.

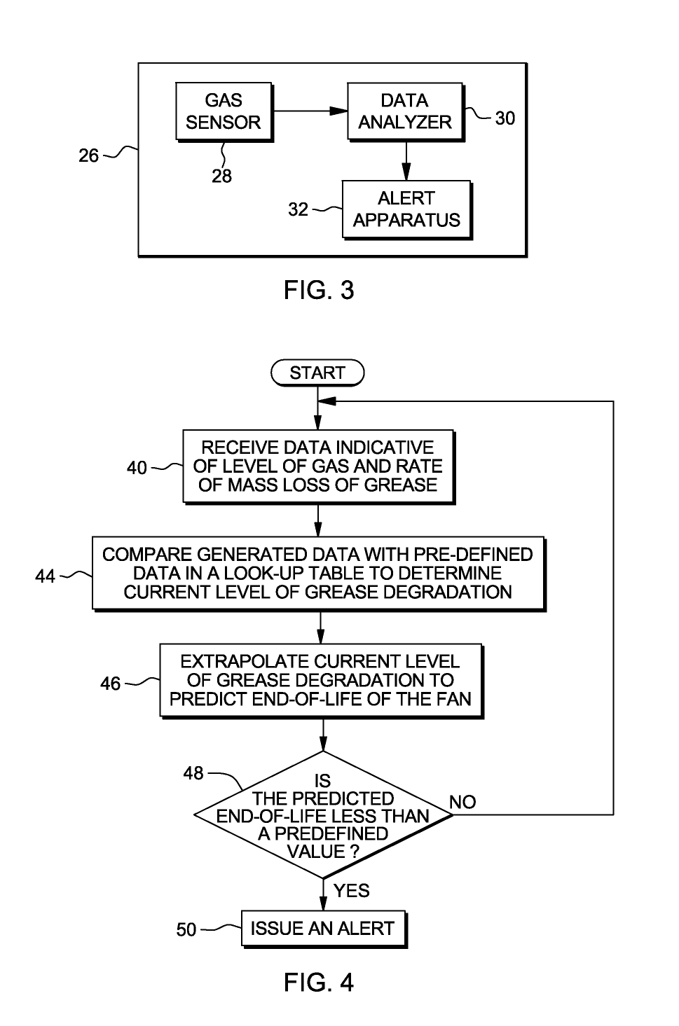

FIG. 3 illustrates a block diagram of the fan failure detection device 26 of FIG. 1 according to one embodiment of the present invention. Fan failure detection device 26 comprises a gas sensor 28 such as a Volatile Organic Compound Sensor or inorganic gas sensor to facilitate monitoring the grease degradation of fan 24. Gas sensor 28 detects volatile organic compounds/gases (VOCs) or inorganic gases off-gassed from grease 25 in bearing assembly 25 of fan 24. This allows for the grease to be automatically monitored without having to manually sample the grease from the bearing assembly.

In one embodiment of the present invention, gas sensor 28 comprises a silicon chip with a chemo-sensitive polymer layer tailored for specific VOCs or inorganic gases for a specific grease formulation. The chip is positioned in the airflow of the fan. VOCs or inorganic gases generated from the grease in the fan bearing will be carried by the air stream flowing from the fan to the chip. As the VOCs or inorganic gases pass over the chip, the VOCs or inorganic gases interact with the chemo-sensitive polymer layer of the chip. As the chip detects VOCs or inorganic gases, the chip generates an analog signal corresponding to the concentration level of VOCs or inorganic gases. The concentration level of the VOCs or inorganic gases and the generated signal correspond directly to the level of breakdown of the grease. The concentration level of VOCs or inorganic gases also indicates the rate of mass loss of the grease, i.e. the rate at which the existing amount of grease is being lost due to the excess friction and excess heat. For an embodiment of the present invention where the data analyzer function 30 is implemented with circuitry, the gas sensor 28 outputs an analog signal corresponding to the concentration level of VOCs or inorganic gases to the data analyzer function 30 for processing. (For another embodiment of the present invention described later where the data analyzer function 30 is implemented in software executed by the computer system, the gas sensor 28 also converts the analog signal to digital measurement data using a known analog to digital converter circuit, and transmits, by wire or wireless, the digital measurement data to the data analyzer function 30 for processing.)

Fan failure detection device 26 also comprises the data analyzer function 30, implemented as an application specific integrated circuit (“ASIC”) in one embodiment of the present invention, for processing the digital data generated by gas sensor 28. In this ASIC embodiment of the present invention, the data analyzer function 30 is implemented in circuitry, optionally with some of the function implemented by program code stored on a read only memory or other storage device and executed by a processor in the ASIC. Data analyzer function 30 compares the level of VOCs or inorganic gases to the known thermogravimetric response of the grease in the fan bearing to determine the current level of degradation of the grease and rate of mass loss of the grease.

Data analyzer function 30 makes the comparison by comparing the analog signal output from the gas detector to a series of predetermined reference voltages. Each of the reference voltages corresponds to a predetermined level of grease breakdown, predetermined rate of mass loss of the grease and/or predetermined amount of consumed life of the fan. The correlation of each reference voltage to the predetermined level of grease breakdown, predetermined rate of mass loss of the grease and/or predetermined amount of consumed life of the fan was previously determined through experimentation/test. Thus, in this embodiment of the present invention, the known thermogravimetric response of the grease is represented by the series of predetermined reference voltages and corresponding outputs of the data analyzer function 30, i.e. whether or not the data analyzer function 30 triggers an alarm.

Alternately, data analyzer function 30 makes the comparison by supplying the represented signal to three linear or nonlinear amplifiers whose outputs indicate the level of grease breakdown, rate of mass loss of the grease and amount of consumed life of the fan, respectively. The linearity or nonlineararity of each of these amplifiers was designed based on the known thermogravimetric response of the grease. Alternately, data analyzer function 30 makes this comparison by converting the output signal to a digital signal and comparing the represented signal output from the gas detector to a table which in one column lists a series of reference levels and in another column lists the corresponding level of grease breakdown, rate of mass loss of the grease and amount of consumed life of the fan as was previously determined through experimentation/test. The table also correlates the predetermined level of grease breakdown, predetermined rate of mass loss of the grease and/or predetermined amount of consumed life of the fan correlation of each reference voltage to the predicted end-of-life of the grease. Alternately, data analyzer function 30 extrapolates the current rate of mass loss linearly to a predetermined failure level to determine the time until end-of-life of the grease, and in turn the time until end-of-life of the fan.

Data analyzer function 30 then signals alerting apparatus/alarm 32 to notify an operator of computer 60 via audible alarm and/or flashing light and display, etc. that fan 24 is showing early signs of failure and indicates the predicted date of failure of fan 24. Alternately, alerting apparatus 32 can communicate to computer 60 the early signs of failure and the predicted date of failure of fan 24, and in response, computer 60 can notify the operator via the computer monitor, e-mail, text message, etc.

In the foregoing embodiment, fan failure detection device 26 is housed in a module supplied with electric power. The module includes the gas sensor 28, data analyzer function 30, and alert apparatus 32.

In a specific embodiment of the present invention, a compound is added to grease 27 of fan bearing 25 for the purpose of generating one or more predetermined gases which gas sensor 28 can detect. The compound is selected such that the degradation temperature of the added compound is lower then the degradation temperature of the grease so the predetermined gas triggers the gas sensor 28 before the grease begins to substantially degrade. This will allow sufficient time, for example, one month, to notify a user to take corrective action. Similarly, the degradation temperature of the added compound which is selected is not excessively low to prevent the predetermined gas from triggering a false alarm with gas sensor 28, i.e. before the grease begins to substantially degrade. Grease 27 typically begins to degrade at 225-250° C. Operating temperature of a fan is typically less then 70° C. Thus, adding a compound having a degradation temperature of 100-200° C. improves the ability to detect grease degradation. For example, a compound that begins to degrade at 150° C. is added to grease 27 that begins to significantly degrade at 225° C. At 150° C., the compound in the grease 27 emits the predetermined gas, triggering the gas sensor.

In one embodiment, azodicarbonamide is added to known grease 27 such as Kluber GLY 32, KluberQuiet BQ 72-72, or Multemp SRL/Multemp SB-M. By way of example, the ratio is 1% azodicarbonamide to 99% of this grease. Azodicarbonamide is a yellow, odorless crystalline powder that decomposes at 200° C. with evolution of nitrogen, carbon monoxide, carbon dioxide, and ammonia gases. For those greases that begin to degrade at temperatures lower than 200° C., the decomposition temperature of azodicaronamide can be lowered to 170° C. by use of activation agents or oxidizers such as ZnO. Additionally, incorporation of a synergist, such as urea at a ratio of 1% urea to 100% azodicarbonamide, to the azodicarbonamide lowers the decomposition temperature even further.

Ammonia gas is generally not present in the ambient atmosphere so presence of ammonia can be linked to breakdown of the grease. Ammonia can be detected using ammonia sensors such as solid state gas sensors, conducting polymer gas sensors, mixed oxide gas sensors, amperometric gas sensors, and catalytic field-effect devices.

By way of example, ammonia sensors are implemented as a silicon microchip. One such silicon chip is a TGS 826 manufactured by Figaro USA Inc. In this embodiment of the present invention, gas sensor 28 includes this type of chip and the thresholds for the data analyzer function 30 are set to levels corresponding to early breakdown of the grease and therefore, early breakdown of the fan, with sufficient advance notice, such as one month. This chip can detect small levels of ammonia gas, such as 1 PPM in the ambient atmosphere. Thus, very small levels of ammonia-emitting compound are needed in the grease formulation. Other compounds generally known to one skilled in the art may also be added to the grease formulation to release ammonia or other pre-determined gases, that can be detected by gas sensor 28, and release these gases at temperatures occurring during early breakdown of the grease.

Data analyzer function 30 and alert apparatus 32 can alternately be implemented as computer instructions stored on a hard drive of computer 60 and executed by a processor 52 via a RAM 56 of computer 60, according to another embodiment of the present invention. In this example, the digital data output from gas sensor 28 is input to computer 60 for processing via a wired or wireless connection.

FIG. 4 illustrates a flow chart describing the function of data analyzer 30 and alert apparatus 32 implemented as a computer program. At step 40, data analyzer program 70 receives a (wired or wireless) digital signal from gas sensor 28 representing the concentration level of gas(es) off-gassed from grease 27 (without or without the additive compound) in bearing assembly 25 of fan 24. The digital signal also represents the rate of mass loss of the grease or compound. At step 44, data analyzer program 70 compares the data represented by the digital signal, using a predefined look-up table, to the known thermogravimetric response of the grease in the fan bearing, to determine the current level of grease degradation, rate of mass loss of the grease and/or expected remaining life of the fan. For example, the known thermogravimetic response indicates current grease degradation based on known specific values for levels of gas and specific values for rate of mass loss of the grease. Alternately, data analyzer program 70 extrapolates the current level of grease degradation, at step 46, to predict the end-of-life of the grease, and in turn the end-of-life of the fan (if this information is not contained in the table). The extrapolation is based on mass loss data as a function of time, or rate or mass loss. Data Analyzer 30 uses the determined rate of mass loss to predict the end-of-life of the grease.

Next, at decision step 48, data analyzer program 70 compares the predicted end-of-life to a predetermined threshold, such as one month, to determine whether the predicted end-of-life of the fan is less than a predefined date. If it is determined at decision step 48 that the predicted end-of-life of the fan is not less than the predefined value, fan failure detection device 26 continues to monitor and process gasses off-gassed from the fan but does not activate the alarm. However, if it is determined at decision step 48 that the predicted end-of-life of the fan is less than the predefined value, data analyzer program 70 notifies alert program 80 which in turn alerts a user of a failing fan at step 50.

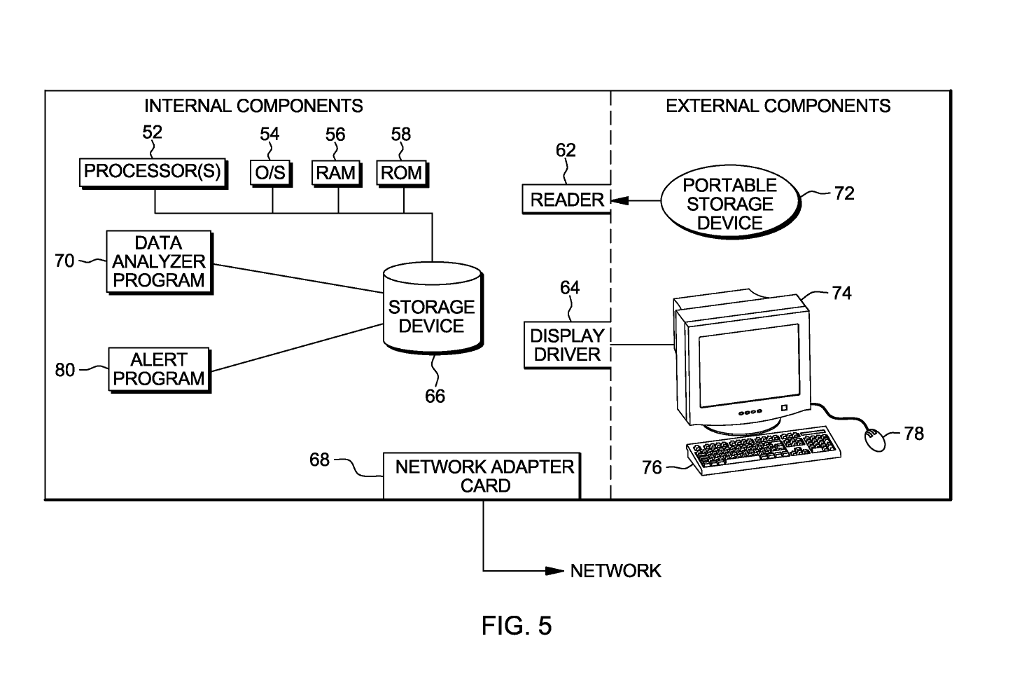

Referring now to FIG. 5, a block diagram of the computing hardware and software of the computer 60 of FIG. 1, excluding the fan and other mechanical parts, and including the data analyzer program 70 and alert program 80 of FIG. 4, is described. The computer 60 includes a known processor(s) 52, a computer-readable RAM 56 and ROM 58 on a bus 51, and a known operating system 54 and computer-readable tangible storage device(s) 66. The data analyzer program 70 and the alert program 80 is stored on the computer-readable tangible storage device(s) 66 for execution by one or more of the processor(s) 52 via RAM 56.

Typically the computer-readable tangible storage device 66 is a magnetic disk storage device either internally installed in the computer 60 as a hard drive or externally accessible by computer 60. Alternately, the computer-readable tangible storage device 66 is a semiconductor storage device, such as flash memory, or any other computer-readable tangible device that can store and contain a computer program and other forms of data.

Data analyzer program 70 and alert program 80 can be loaded into server 60, via reader 62, from a portable computer-readable tangible storage device 72 such as a CD-ROM, DVD, memory stick, magnetic tape, or other forms of magnetic or optical disk or semiconductor storage device. Alternately, data analyzer program 70 and alert program 80 can be downloaded to computer 60 from the Internet or other network via network adapter card 68, for example, comprising copper wires, optical fibers, wireless transmission, routers, firewalls, switches, gateway computers, and/or edge servers.

Computer 60 includes display driver 64 for interfacing with external display 74. Computer 60 also includes keyboard 76 and mouse 78 for interfacing with computer 60.

The description above has been presented for illustration purposes only. It is not intended to be an exhaustive description of the possible embodiments. One of ordinary skill in the art will understand that other combinations and embodiments are possible. Accordingly, the above description is intended to embrace all such possible embodiments that fall within the scope of the appended claims.

1. A system for predicting a fan failure comprising:
a sensor to detect a gas emitted from grease in the fan wherein a concentration level of the emitted gas is indicative of grease degradation;
circuitry coupled to the sensor to compare the level of the detected gas to a predetermined level; and
an alert apparatus coupled to the circuitry to generate an alert responsive to the circuitry determining that the level of the detected gas exceeds the predetermined level.

2. The system of claim 1 wherein the sensor detects volatile organic compounds emitted from the grease in the fan.

3. The system of claim 1 wherein the sensor detects a predetermined gas emitted from an additive incorporated in the grease.

4. The system of claim 3, wherein the additive comprises azodicarbonamide.

5. The system of claim 3, wherein the additive, at a predetermined temperature, degrades and begins to emit the predetermined gas at a predetermined concentration, and the grease degrades at a temperature greater than the predetermined temperature.

6. The system of claim 1, wherein the alert apparatus generates an electronic-mail message to notify a user of a fan failure.

7. The system of claim 1:
wherein the sensor generates an analog signal with a voltage level corresponding to the concentration level of the emitted gas; and
wherein the circuitry correlates the analog signal to the level of grease degradation.

8. A computer program product for predicting a fan failure, the computer program product comprising:
one or more computer-readable tangible storage devices and program instructions stored on at least one of the one or more storage device, the program instructions comprising:
program instructions to receive data representative of detected gas emitted from grease in the fan wherein the concentration level of emitted gas is indicative of grease degradation;
program instructions to compare the level of the detected gas to a predetermined level; and
program instructions to generate an alert responsive to determining that the level of the detected gas exceeds the predetermined level.

9. The computer program product of claim 8, wherein the detected gas is a volatile organic compound.

10. The computer program product of claim 8, wherein the detected gas is a predetermined gas emitted from an additive incorporated in the grease.

11. The computer program product of claim 10 wherein the additive comprises azodicarbonamide.

12. The computer program product of claim 10 wherein the additive, at a predetermined temperature, degrades and begins to emit the predetermined gas at a predetermined concentration, and the grease degrades at a temperature greater than the predetermined temperature.

13. The computer program product of claim 8, wherein the program instructions to generate an alert, generate an electronic-mail message to notify a user of a fan failure.

14. The computer program product of claim 8, further comprising:
program instructions, stored on at least one of the one or more storage device, to compare the concentration level of the detected gas with data in a pre-defined look-up table to determine the current level of grease degradation;
program instructions, stored on at least one of the one or more storage device, to extrapolate the current level of grease degradation to determine the residual life of the grease; and
program instructions, stored on at least one of the one or more storage device, to predict the end-of-life of the fan based on the determined residual life of the grease; and
wherein the residual life of the grease is indicative of the end-of-life of the fan.

15. An apparatus for predicting a fan failure, the apparatus comprising:
means for detecting a gas emitted from grease in the fan wherein a concentration level of the emitted gas is indicative of grease degradation;
means for comparing the level of the detected gas to a predetermined level; and
means for generating an alert responsive to determining that the level of the detected gas exceeds the predetermined level.

16. The apparatus of claim 15, wherein the means for detecting a gas detects a predetermined gas emitted from an additive incorporated in the grease.

17. The apparatus of claim 16, wherein the additive comprises azodicarbonamide.

18. The apparatus of claim 15, wherein the additive, at a predetermined temperature, degrades and begins to emit the predetermined gas at a predetermined concentration, and the grease degrades at a temperature greater than the predetermined temperature.

19. The apparatus of claim 15, wherein means for generating an alert, generates an electronic-mail message to notify a user of a fan failure.

20. The apparatus of claim 15, the apparatus further comprising:
means for comparing the concentration level of the detected gas with data in a pre-defined look-up table to determine the current level of grease degradation;
means for extrapolating the current level of grease degradation to determine the residual life of the grease; and
means for predicting the end-of-life of the fan based on the determined residual life of the grease;
wherein the residual life of the grease is indicative of the end-of-life of the fan.
